(19) United States
(12) Patent Application Publication
(10) Pub. No.: US 2026/0273637 A1
(43) Pub. Date: Sep. 17, 2026

(54) Tool blade, tool fitting, system and power tool

(71) Applicant: Hilti Aktiengesellschaft, Schaan (LI)

(72) Inventors: Jens STAHL, Obergriesbach (DE); Forrest CAI, Shanghai (CN)

(21) Appl. No.: 19/168,513

(22) PCT Filed: Mar. 5, 2024
(86) PCT No.: PCT/EP2024/055672

§ 371 Date: Sep. 24, 2025

(30) Foreign Application Priority Data
Mar. 31, 2023 (EP) 23165959.0

(51) Int. Cl. B23D 61/02; B27B 5/32

(52) U.S. Cl. CPC B23D 61/025; B27B 5/32

(57) ABSTRACT

A tool blade (14) which has a structure (24) that includes at least two elements (22) on at least one side face (26) of the tool blade (14), wherein, about a central blade rotation axis (R) of the tool blade (14), the structure (24) with its elements is rotationally symmetrical with respect to an angle of rotation of less than 360°, in particular of at most 180°, but is not mirror-symmetrical with respect to any diameter of the tool blade (14) passing through the blade rotation axis (R). A tool fitting (12), a tool blade system (15) and a power tool (10). It allows particularly safe working.

### BACKGROUND

The invention relates to a tool blade, e.g. a circular saw blade.

Tool blades of this kind can be used together with power tools such as circular saws or angle grinders.

### SUMMARY OF THE INVENTION

Tool blades of this kind often need to be mounted the right way round. Otherwise, saw teeth will be incorrectly aligned, for example, with the result that a saw blade will not cut in an optimum manner or will not cut at all. Furthermore, there is the risk that the power tool will jam in a workpiece being machined, possibly leading to a sudden recoil or a countertorque. The power tool may be torn out of the hand of a user. Accidents and injuries may be the result. A similar statement applies when the power tool is guided by a construction robot. Here too, breakdowns or even damage may be the result.

It is an the object of the present invention to offer a tool blade and devices for using such a tool blade which enable them to be used particularly safely.

The present invention provides a tool blade which has a structure that comprises at least two elements on at least one side face of the tool blade, wherein, about a central blade rotation axis of the tool blade, the structure with its elements is rotationally symmetrical with respect to an angle of rotation of less than 360°, in particular of at most 180°, but is not mirror-symmetrical with respect to any diameter of the tool blade passing through the blade rotation axis.

The tool blade thus has n-fold rotational symmetry, where n is greater than 1.

The rotational symmetry and the mirror symmetry may be subject to assessment in a plan view perpendicular to the side face.

This is based on the consideration, which is surprisingly simple in terms of design and is nevertheless surprisingly effective, that such a combination of rotational symmetry with the absence of mirror symmetry gives the tool blade an orientation such that confusion between the sides of the tool blade during mounting can be excluded.

As a result, the tool blade can now only be mounted the right way round. Mounting the wrong way round is excluded. Thus, the tool blade is used correctly, and the risks described at the outset can be minimized or even excluded.

Moreover, the rotational symmetry ensures that the tool blade can remain balanced. Even at high speeds of rotation, it can thus rotate with little vibration. By virtue of this too, a user of the power tool can guide the tool blade particularly safely by hand. Damage to health due to high vibrational loads on the hand of the user can be avoided.

The tool blade can be a saw blade for a circular saw, for example. It may be a wood saw blade. It is also conceivable for the tool blade to be designed as a blade for an angle grinder. In general, it can be a saw blade, an abrasive disk, e.g. for grinding masonry, e.g. concrete, wood or the like.

A special case of such n-fold rotational symmetry is obtained if the structure is point-symmetrical with respect to the blade rotation axis, i.e. in the case of 2-fold rotational symmetry. For this purpose, it is possible, in particular, for respective pairs of two of the elements of the structure to be formed in point symmetry relative to one another with respect to the blade rotation axis.

At least one of the elements can comprise an aperture. The element can be or comprise a through-opening. Apertures of this kind can be produced easily, e.g. by drilling or milling. Since the apertures thus do not project beyond the surface of the side face of the tool blade, the tool blade can also be used with conventional power tools, e.g. conventional circular saws or angle grinders. In particular, the apertures do not hinder mounting on conventional power tools of this kind.

However, it is also conceivable for at least one of the elements to comprise a projection which projects from the side face. At least two such projections can be provided in order to ensure the necessary rotational symmetry.

By virtue of the fact that the projections project from the side face, a user can immediately ascertain whether the tool blade is mounted correctly, even during mounting. If the power tool is configured to fix the tool blade on the power tool at the projections, it is completely impossible for the tool blade to be mounted the wrong way round as it would immediately slide off the power tool. A user is thus directly prevented from putting the power tool into operation until the tool blade has been mounted the right way round on said tool.

At least two of the elements of the structure can be arranged on at least two different radii around the blade rotation axis. It is thereby possible to influence the vibrational behavior of the tool blade during rotation, thus enabling use with even less vibration.

It is conceivable for the tool blade to have a central through-opening, and by this means too the tool blade continues to be usable for conventional power tools, which generally require such a central through-opening.

However, it is also possible for the tool blade not to have a central through-opening. On the contrary, the tool blade can be fixable and/or fixed directly on a suitably designed power tool via its structure elements, in particular by means of its apertures and/or projections. By virtue of the fact that a central region of the tool blade also remains occupied by material, the stability of the tool blade can be improved.

A particularly simple structure that can be produced at low cost can have just two elements, for example. In this case, it is advantageous if the elements are not of circular design in order to avoid mirror symmetry despite the small number of elements. To obtain the rotational symmetry, the two elements should lie opposite one another along a diameter through the blade rotation axis.

A particularly simple possibility for the production of the structure is also obtained if at least one of the elements, in particular the at least two elements, comprises a noncircular shape, e.g. an elongate hole. A noncircular shape of this kind furthermore makes it easier, at least as a contributory factor, to fix the tool blade in a stable manner on the tool fitting by means of the elements. The edge extended relative to a circular edge results in an extended contact zone between complementary elements of a tool fitting which engage in the elements and the tool blade. It is thus possible to reduce pressure loads, and fraying of the elements can be reduced or avoided. The life of the tool blade can thus be extended.

The structure can also have at least two elements of the same kind that differ in their size. This results in design configuration possibilities that enable the vibrational behavior during the rotation of the tool blade to be additionally modified.

At least one of the elements can have a chamfer, thus enabling the tool blade to be mounted more easily on a tool fitting of a power tool. The chamfer can also contribute to reducing or avoiding the flight of sparks and noise generation by the tool blade during rotation.

The tool blade can have an electric, magnetic and/or electromagnetic function. In particular, the tool blade can have at least one electronic system. For example, the tool blade can be fitted with a sensor.

It is conceivable that at least one of the elements is electrically conductive. If the element has an aperture or a through-opening, this can be understood to mean that a surface region of an edge of the aperture or of the through-opening is formed from an electrically conductive material.

It is then further conceivable that the at least one element is designed as an electric contact. Thus, if the tool fitting of the power tool has mating contacts of complementary design for example, an electric contact can be established between the power tool and the electronics of the tool blade. It is thus possible, for example, for the sensor to detect a property, e.g. a degree of wear, of the tool blade and to transmit corresponding data to the power tool via the elements.

Via at least one of the elements of the structure, the tool blade can be driven, in particular by a power tool.

At least one of the elements of the structure can be situated in an outer half, e.g. with a radius in the range of from 55 to 100 percent, in particular within a range of from 65 to 85 percent, of the initial diameter of the tool blade. If the tool blade is driven via such an element situated in the outer half, only small tangential forces acting on the tool blade are required to achieve a particular torque. The tool blade may be subject to slight internal stresses during rotation. It is thus possible to increase the life of the tool blade. It is also conceivable to subject the tool blade to an increased torque on account of the improvement in durability that can thereby be achieved.

In the case of cut-off disks for angle grinders, for example, it is however advantageous if the element is not situated too far toward the outside, e.g. in the region of over 85 percent of the initial diameter, since otherwise it could be prone to wear.

Moreover, over and above the technical effects mentioned, within the scope of the abovementioned measures for achieving the respective advantages, it is possible, by fine positioning, by the size, color and shape of the elements, and by lettering and the like, to achieve degrees of freedom in the design in order to give the tool blade a particularly attractive appearance.

The scope of the invention furthermore encompasses a tool fitting on which a tool blade of the type described above can be mounted. The tool fitting has a complementary structure on at least one side face of the tool fitting, wherein the complementary structure comprises at least two complementary elements, wherein, about a central rotation axis of the tool fitting, the complementary structure with its complementary elements is rotationally symmetrical with respect to an angle of rotation of less than 360°, in particular of at most 180°, but is not mirror-symmetrical with respect to any diameter of the tool fitting passing through the blade rotation axis.

A tool fitting of this kind can act as an adapter for conventional power tools. A tool blade of the type described above can be mounted on it.

The tool fitting can have a mounting plate. The complementary structure can be formed on the mounting plate.

It is conceivable to arrange the tool fitting, in particular the mounting plate, on a conventional power tool. The tool blade can then also be capable of being used on a conventional power tool converted in this way, with the advantages described above.

It is also conceivable to provide a tool fitting of this kind directly on a power tool. In the case of such a power tool, the possibility of the tool blade accidentally being mounted the wrong way round is thus excluded.

At least one of the complementary elements can have a chamfer, thus simplifying the mounting of a tool blade.

In particular, the complementary structure can be designed to be complementary to the structure of the tool plate. If, for example, the structure of the tool plate has apertures as elements, the complementary structure can have projections, e.g. in the form of pins, as complementary elements at the positions corresponding to the apertures.

The tool fitting can be designed for tool-free mounting of the tool blade. Particularly if the tool blade has at least one projection, e.g. an angled projection, as an element, the projection can be inserted into an aperture in the tool fitting. The tool blade can then be fixed by a rear engagement means and/or a latching mechanism on said tool fitting. In this context, use can be made of the fact that mounting of the tool blade the wrong way round cannot occur. The latching mechanism and/or the rear engagement means can thus be designed in such a way that they lock automatically when the tool blade is rotated or that at least automatic release of the connection between the tool blade and the tool fitting is excluded.

At least one complementary element of the complementary structure can be electrically conductive. In the case of an aperture or a through-opening, this can be understood to mean that a surface of an edge region of the complementary element is electrically conductive.

At least one of the complementary elements can have a chamfer, and it can therefore be pushed more easily onto or into the complementary element during the mounting of the tool blade.

The scope of the invention furthermore encompasses a tool blade system which has a tool fitting of the type described above and a tool blade of the type described above. In the case of this system, the complementary structure of the tool fitting is designed to be complementary to the structure of the tool blade, thus enabling the tool blade to be mounted on the tool fitting, with mounting the wrong way round being excluded.

The scope of the invention furthermore encompasses a power tool which is configured to receive a tool blade and to drive it in rotation, comprising a tool fitting for receiving the tool blade, wherein the tool fitting has a tool fitting of the type described above. The power tool can be a circular saw, for example. It can also be an angle grinder. The power tool can be a handheld power tool. It is also conceivable for the power tool to be formed on a construction robot, e.g. for carrying out construction work on buildings, civil engineering sites or industrial plants.

Precisely in the case where the power tool is formed and/or arranged on an end effector of a construction robot, it is possible to dispense with additional sensors for checking whether a tool blade has been mounted the right way round on the power tool, or sensors that are present in principle can be simplified. For example, a sensor system which merely checks for the presence of the tool blade in the tool fitting may be sufficient. Precisely in the case of high degrees of autonomy of the construction robot, relevant safety requirements can be satisfied more easily by virtue of the tool blade and, in particular also, the tool blade system.

Moreover, weight can be saved, especially on an end effector of the construction robot, thus improving its maneuverability.

In the case of handheld power tools, the initially stated risks to a user of the handheld power tool can be reduced.

Further features and advantages of the invention will be apparent from the detailed description of exemplary embodiments of the invention that follows, with reference to the figures of the drawing, which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and elucidated in detail in the description that follows.

### BRIEF DESCRIPTION OF THE DRAWINGS

FIG. 1 shows a detail of a power tool having a tool blade system,

FIGS. 2, 3, 4, 5, 6, 7, 8, 9 and 10 show a number of tool blades,

FIG. 11 shows a complementary element, and

FIG. 12 shows a tool blade in a side view.

In the description of the figures that follows, comprehension of the invention is facilitated by use of the same reference signs in each case for identical or functionally corresponding elements.

### DETAILED DESCRIPTION

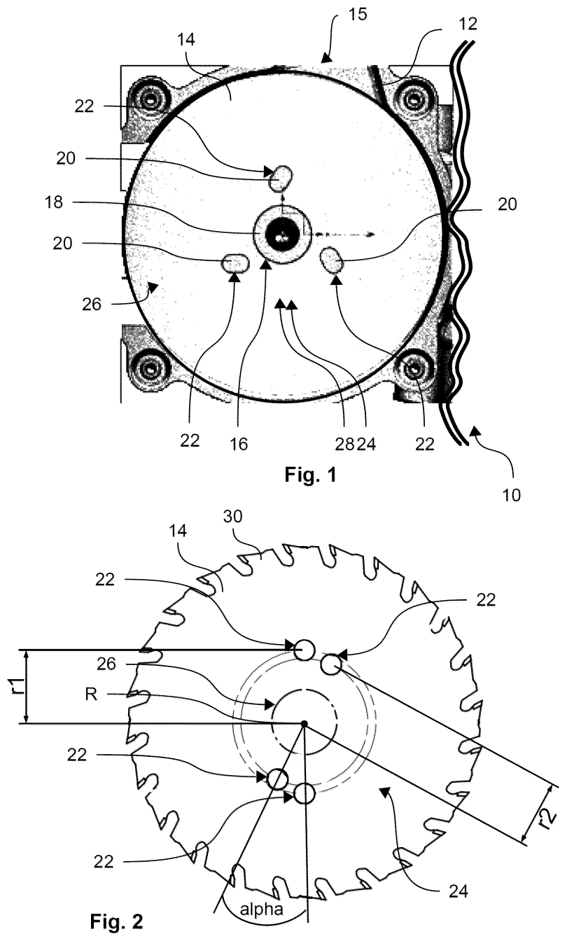

FIG. 1 shows a detail of a power tool 10 having a tool fitting 12, in which a tool blade 14 is mounted, in a side view. The tool fitting 12 and the tool blade 14 form a tool blade system 15.

The power tool 10 is designed as an angle grinder.

The tool blade 14 is designed as a cut-off disk, e.g. for cutting masonry or metal.

The tool blade 14 has a central through-opening 16. By means of this opening, the tool blade 14 is seated on a rotation axis 18 of the tool fitting 12.

The tool fitting 12 furthermore has a plurality of pin-shaped complementary elements 20, which engage in elements 22 of a structure 24. The elements 22 are designed as elongate holes and pass through the tool blade 14. They thus have a cross section in the form of a rounded rectangle. The complementary elements 20 are designed to be complementary to the elements 22. In the embodiment illustrated, they therefore likewise have a cross section in the form of a rounded rectangle.

Since the elements 22 project through the tool blade 14, the tool blade 14 has the structure 24 not only on its side face 26 that is visible in FIG. 1 but also on the opposite side face that is not visible in FIG. 1.

The elements 22 and thus also the complementary elements 20 run obliquely with respect to their respective radius lines and also obliquely with respect to their respective tangents.

As a result, the structure 24, in particular the elements 22 thereof, have a threefold rotational symmetry. At the same time, however, the structure 24 does not have mirror symmetry with respect to any diameter through the central through-opening 16 that forms a blade rotation axis of the tool blade 14.

The complementary elements 20 form a complementary structure 28. The complementary structure 28 is thus designed to be complementary to the structure 24. It thus has the same threefold rotational symmetry while, at the same time, there is no mirror symmetry with respect to any diameter through the rotation axis 18.

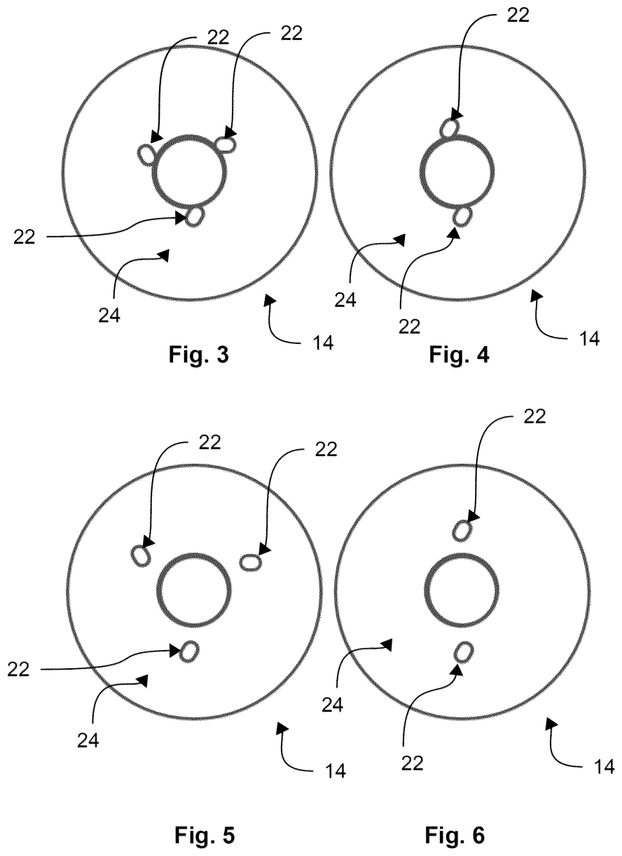

FIG. 2 shows a tool blade 14 which is designed as a circular saw blade, e.g. for machining wooden materials. In particular, the tool blade 14 in this embodiment as a circular saw blade has a multiplicity of saw teeth 30, of which only one saw tooth 30 is provided with a reference sign in FIG. 2 in order to simplify the illustration. A central point of the tool blade 14 and thus a blade rotation axis R of the tool blade 14 are also indicated.

The tool blade 14 in turn has a structure 24 formed from elements 22. The elements 22 are designed as circular through-openings. In this case, a total of four elements 22 is provided, which are each formed on two different radii r1, r2 and are each situated opposite one another in pairs. The structure 24 is thus point-symmetrical, i.e. it has twofold rotational symmetry.

Elements 22 are each offset in pairs with respect to their adjacent elements 22 by a center angle alpha. The center angle alpha is less than 90° and greater than 0°, e.g. in the range of from 10° to 40°.

Thus, the structure 24 once again has no mirror symmetry with respect to any diameter through the central through-opening 26 or to the blade rotation axis R of the tool blade 14.

FIG. 3 to FIG. 10 show various embodiments of tool blades 14 in schematic illustrations. In particular, different structures 24 can be seen.

FIGS. 3, 5, 7 and 9 show embodiments with structures 24 which have threefold rotational symmetry.

FIGS. 4, 6, 8 and 10 show embodiments with structures 24 which have twofold rotational symmetry, i.e. point symmetry.

FIGS. 3 to 6 have elements 22 that are designed as elongate holes.

FIGS. 7 to 10 have elements 22 that are of circular design.

FIGS. 3 and 5 show embodiments with a total of three elements 22.

FIGS. 4 and 6 show embodiments with a total of two elements 22.

FIGS. 7 and 9 show embodiments with a total of six elements 22.

FIGS. 8 and 10 show embodiments with a total of four elements 22.

As can be seen from FIGS. 7 and 8, the rotational symmetry with an absence of mirror symmetry can also be achieved if elements 22 are arranged on the same radius but differ in their shape, e.g. in their size.

The different structures 24 in FIGS. 3 to 10 are also associated with different bending stiffness and/or different vibrational behavior.

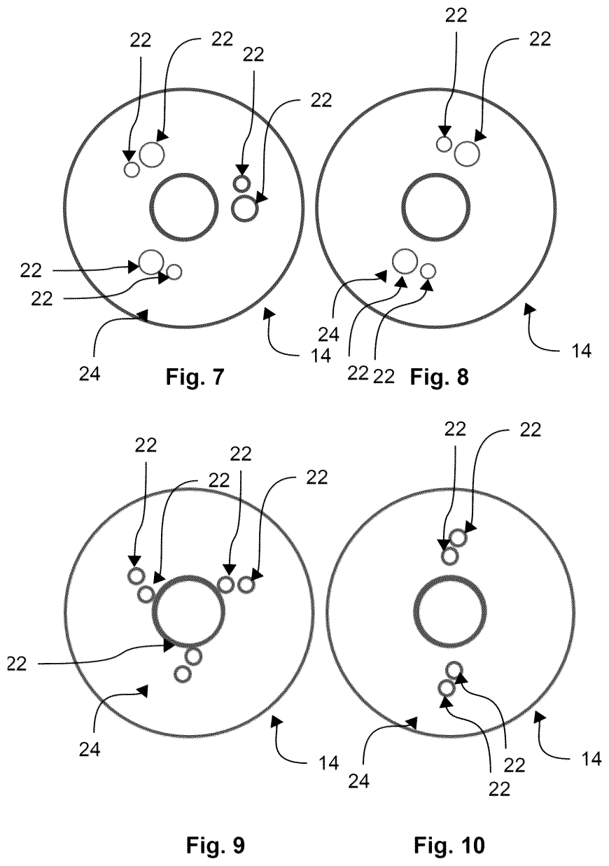

FIG. 11 shows a complementary element 20. The complementary element 20 has a chamfer 32. In particular, the chamfer 32 is chamfered with a chamfer angle beta in the range of from 10° to 85°, in particular between 10° and 40°, e.g. 30°.

In the exemplary embodiment shown, the chamfer 32 is formed symmetrically with respect to the longitudinal axis of the complementary element 20. In alternative embodiments, it is conceivable for the chamfer 32 to be formed asymmetrically. An asymmetrical chamfer 32 can make the mounting of the tool blade 14 easier.

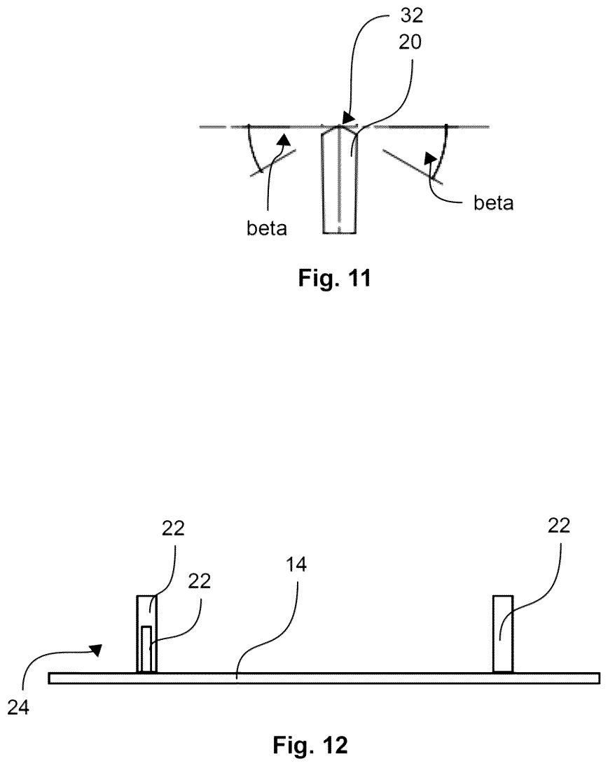

FIG. 12 shows another tool blade 14 in a schematic side view. It has a total of four elements 22, of which only three elements 22 are visible on account of the side view according to FIG. 12. A further element 22 is concealed by another element 22.

In this exemplary embodiment, the elements 22 are designed as projections. A tool blade 14 of this kind can be mounted on a tool fitting 12 (see FIG. 1), on which the complementary elements 20 are designed as blind holes, for example. In the mounting process, the elements 22 can then be pushed into the blind holes or the complementary elements 20. The tool blade 14 can thus also be secured on the tool fitting 12 by means of its elements 22.

### LIST OF REFERENCE SIGNS

10 Power tool
12 Tool fitting
14 Tool blade
15 System
16 Through-opening
18 Rotation axis
20 Complementary element
22 Element
24 Structure
26 Side face
28 Complementary structure
30 Saw tooth
R Blade rotation axis
alpha Center angle
r1 Radius
r2 Radius

What is claimed is:

1-13. (canceled)

14. A tool blade comprising:
a central blade rotation axis;
a structure including at least two elements on at least one side face, wherein, about the central blade rotation axis, the structure with the at least two elements being rotationally symmetrical with respect to an angle of rotation of less than 360°, but not mirror-symmetrical with respect to any diameter of the tool blade passing through the blade rotation axis.

15. The tool blade as recited in claim 14 wherein the structure is point-symmetrical with respect to the blade rotation axis.

16. The tool blade as recited in claim 14 wherein at least one of the at least two elements has an aperture.

17. The tool blade as recited in claim 14 wherein at least one of the at least two elements has a through-opening through the tool blade.

18. The tool blade as recited in claim 14 wherein at least one of the at least two elements has a projection projecting from the side face.

19. The tool blade as recited in claim 14 wherein at least two of the at least two elements are arranged on at least two different radii around the blade rotation axis.

20. The tool blade as recited in claim 14 wherein the tool blade has a central through-opening.

21. The tool blade as recited in claim 14 wherein at least one of the elements has a noncircular shape.

22. The tool blade as recited in claim 14 wherein at least one of the elements has an elongate hole.

23. The tool blade as recited in claim 14 wherein the at least two elements are of a same shape but differing in size.

24. The tool blade as recited in claim 14 wherein at least one of the at least two elements has a chamfer.

25. The tool blade as recited in claim 14 wherein at at least one of the at least two elements is electrically conductive.

26. The tool blade as recited in claim 14 wherein the angle of rotation is at most 180°.

27. A circular saw blade comprising the tool blade as recited in claim 14.

28. A tool fitting, the tool blade as recited in claim 14 mountable on the tool fitting, the tool fitting comprising:
a complementary structure on at least one tool fitting side face, the complementary structure including at least two complementary elements, wherein, about a tool fitting central rotation axis, the complementary structure with the at least two complementary elements being rotationally symmetrical with respect to an angle of rotation of less than 360°, but not mirror-symmetrical with respect to any diameter of the tool fitting passing through the tool fitting central rotation axis.

29. The tool blade as recited in claim 28 wherein the angle of rotation is at most 180°.

30. A tool blade system consisting of the tool fitting as recited in claim 28 and the tool blade, the complementary structure being designed to be complementary to the structure of the tool blade.

31. A power tool comprising: the tool fitting as recited in claim 29 and the tool blade received in the tool fitting, the power tool configured to drive rotation of the tool blade.

32. A circular saw or an angle grinder comprising the powere tool as recited in claim 31.
